(19) United States
(12) Patent Application Publication
(10) Pub. No.: US 2005/0232667 A1
(43) Pub. Date: Oct. 20, 2005

(54) Image forming apparatus having image bearing member and toner removal means

(75) Inventor: Hyoe Iwata, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/104,617

(22) Filed: Apr. 13, 2005

(30) Foreign Application Priority Data
Apr. 15, 2004 (JP) 2004-119879
Apr. 27, 2004 (JP) 2004-130782

(51) Int. Cl. G03G 21/00

(52) U.S. Cl. 399/353

(57) ABSTRACT

The image forming apparatus includes an image bearing member rotated in a predetermined direction and serving to bear an image; and toner removal means including a first touchable/detachable member touchable on or detachable from the image bearing member and detached from the image bearing member in an area there not bearing the toner image, and second touchable/detachable member touchable on or detachable from the image bearing member, and positioned in a downstream side of the first touchable/detachable member in the predetermined rotating direction of the image bearing member, thereby eliminating a toner on the image bearing member; wherein the first touchable/detachable member and the second touchable/detachable member are detached from the image bearing member at approximately same positions. Thus a distance of toner images formed on the image bearing member can be reduced, thereby reducing a time required for image formation.

### BACKGROUND OF THE INVENTION

1. Field of the Invention

The present invention relates to an image forming apparatus provided with toner removal means which includes plural members touchable on or detachable from an image bearing member thereby eliminating a toner on the image bearing member, and more particularly to a sequence of touching and detaching of the touchable/detachable members as toner removal members with or from the image bearing member.

2. Related Background Art

Because of a recent increasing demand for an improvement in an image quality of an image forming apparatus of electrohotographic process, there is disclosed an image forming apparatus equipped with toner removal means which includes plural members touchable on or detachable from an image bearing member, for appropriately executing a toner removal from the image bearing member, required for improving the image quality.

As the means having plural members touchable on or detachable from an image bearing member for eliminating the toner on the image bearing member, Japanese Patent Application Laid-open No. S61-193176 discloses a configuration which removes all the transfer residual toner on the image bearing member and in which the aforementioned member as a touchable/detachable member that is touchable or detachable is detached from the image bearing member in an area where the toner image is not borne, in order to avoid perturbing the toner image on the image bearing member.

Also when the touchable/detachable member maintained in contact with the image bearing member is separated therefrom, the toner dammed up by the touchable/detachable member remains as a streak-shaped heap extending in a direction perpendicular to the rotating direction of the image bearing member. In order to collect such streak-shaped heap in a position, a brush member provided in a downstream side is detached after the lapse of a predetermined time from the spacing of the blade.

However, in the image forming apparatus disclosed in Japanese Patent Application Laid-open No. S61-193176, until the brush member provided in the downstream side is detached, the toner image on the image bearing member cannot pass through an area where the brush member is in contact with the image bearing member, so that an interval of the toner images formed on the image bearing member becomes larger, thereby resulting in a longer time required for image formation.

### SUMMARY OF THE INVENTION

In consideration of the foregoing, an object of the present invention is to provide an image forming apparatus provided with toner removal means which includes plural members touchable on or detachable from an image bearing member thereby eliminating a toner on the image bearing member.

Another object of the present invention is to provide an image forming apparatus capable of reducing a distance of toner images formed on an image bearing member thereby reducing a time required for image formation.

Still another object of the present invention is to provide an image forming apparatus including an image bearing member which bears an image and rotates in a predetermined direction, and a first toner removal member which is able to be touchable to or detachable from said image bearing member, said first toner removal member being detached from said image bearing member in an area in which an toner image on said image bearing member is not borne and removing toner on said image bearing member by applying bias with a predetermined pole in an area in which said first toner removal member touches said image bearing member, a second toner removal member which is positioned in a downstream side of said first toner removal member in the predetermined direction and is able to be touchable to or detachable from said image bearing member, said second toner removal member being detached from said image bearing member in an area in which an toner image on said image bearing member is not borne and removing toner on said image bearing member by applying bias with another pole opposite to the predetermined pole in an area in which said second toner removal member touches said image bearing member, wherein the first touchable/detachable member and the second touchable/detachable member are detached from the image bearing member at approximately same positions.

### BRIEF DESCRIPTION OF THE DRAWINGS

FIG. 1 is a schematic cross-sectional view indicating distances of component members constituting cleaning means in first and second embodiments;

FIG. 2 is a schematic cross-sectional view of an image forming apparatus in the first and second embodiments;

FIG. 3 is a schematic view showing cleaning means in the first embodiment;

FIGS. 4A, 4B, 4C and 4D are schematic views showing touching/detaching operations of the cleaning means in the first and second embodiments;

FIG. 5 is a timing chart showing touching and detaching operations of the cleaning means of the first and second embodiments;

FIG. 6 is a schematic cross-sectional view indicating distances of component members constituting cleaning means of the second embodiment.

### DESCRIPTION OF THE PREFERRED EMBODIMENTS

In the present invention, the aforementioned problems are solved by spacing a first fur brush 21 (first touchable/detachable member) and a second fur brush 31 (second touchable/detachable member), provided in a cleaning apparatus (toner removal means), from an intermediate transfer belt 7 (image bearing member) at approximately same positions thereon.

It is thus rendered possible, in a position on the intermediate transfer belt 7 where a streak-shaped toner heap is formed by a spacing of the first fur brush, to form a streak-shaped toner heap by a spacing of the second fur brush, thereby reducing a time of contact of the second fur brush with the intermediate transfer belt 7. Therefore, a distance of the toner images formed on the intermediate transfer belt 7 can be reduced to avoid a drawback of requiring a longer time for image formation.

In the following, the present invention will be clarified in detail by embodiments thereof.

### First Embodiment

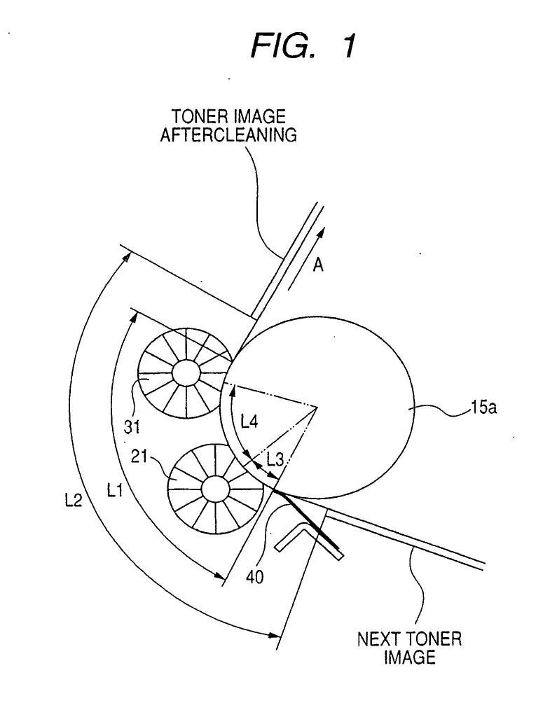

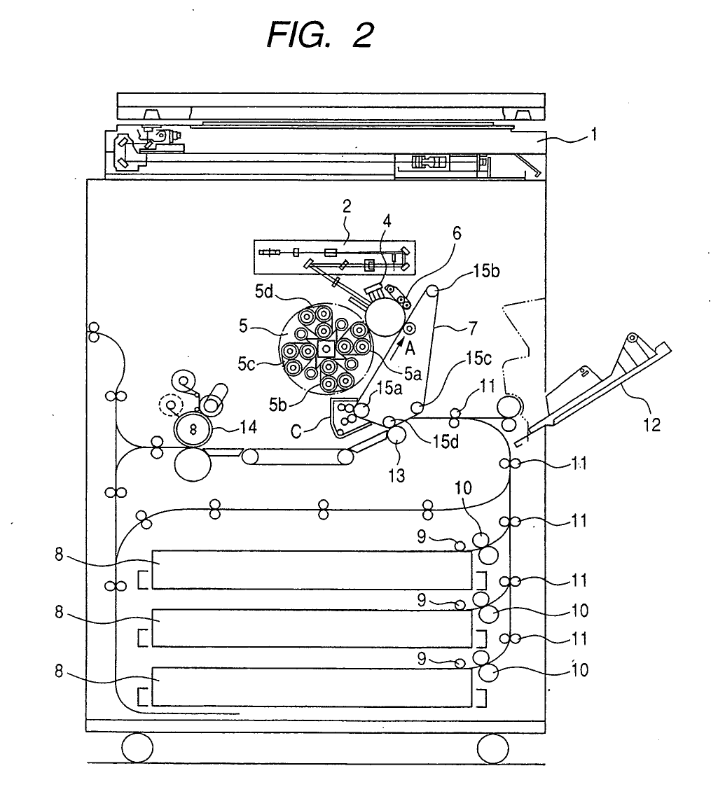

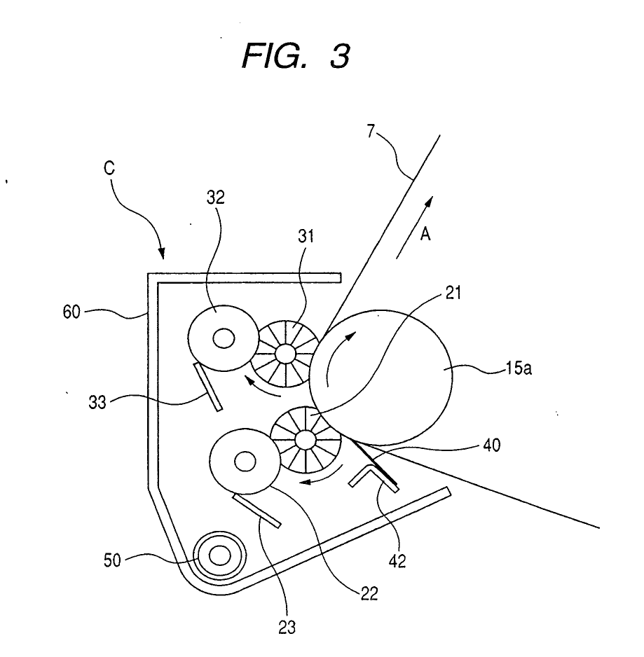

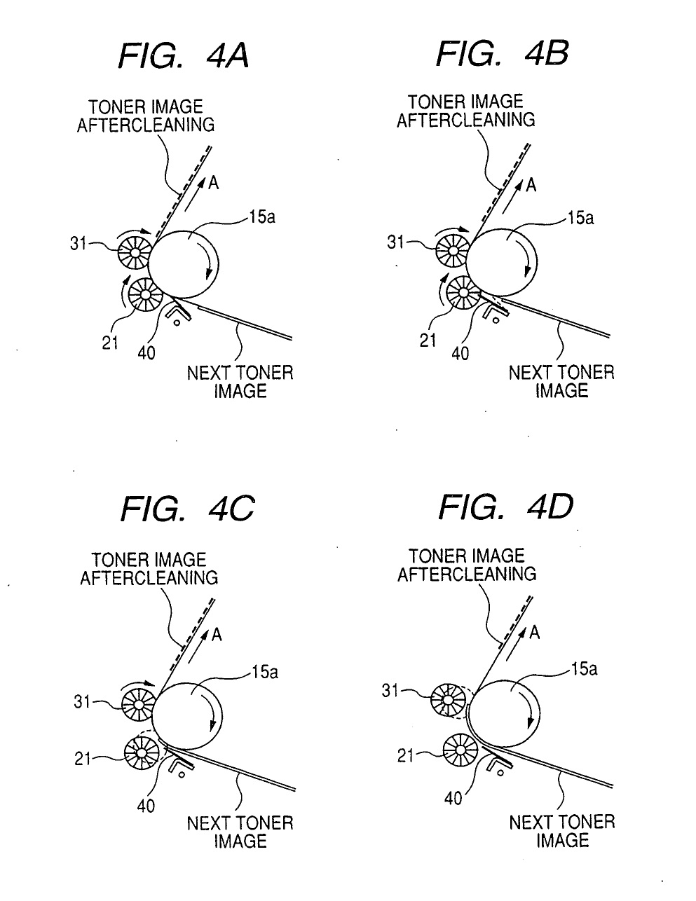

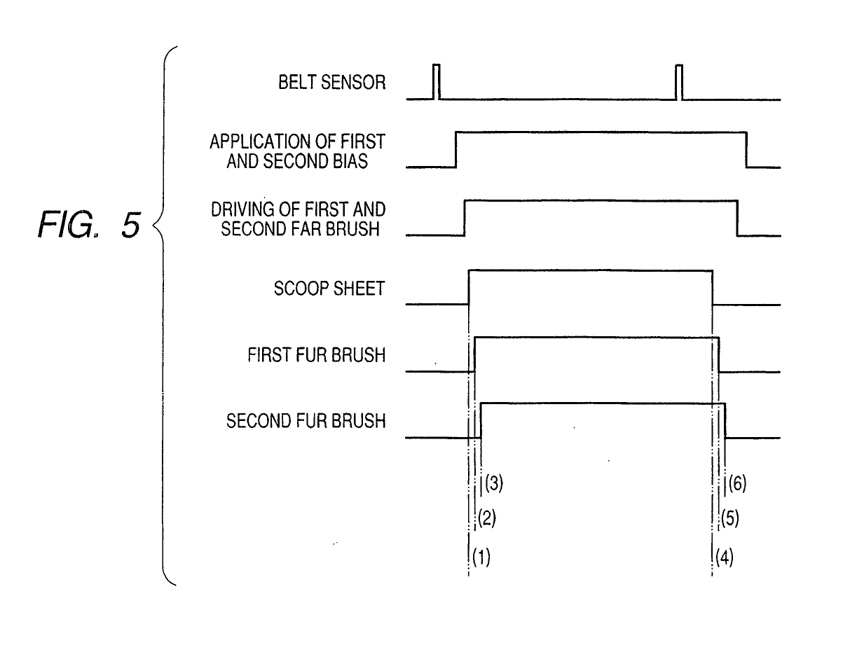

In the following, a cleaning apparatus of a first embodiment of the present invention and an image forming apparatus equipped with such cleaning apparatus will be explained with reference to FIGS. 1 to 5. FIG. 1 is a schematic cross-sectional view indicating distances of component members constituting cleaning means; FIG. 2 is a schematic cross-sectional view of an image forming apparatus; FIG. 3 is a schematic view showing cleaning means; FIGS. 4A, 4B, 4C and 4D are schematic views showing touching/detaching operations of the cleaning means; and FIG. 5 is a timing chart showing touching and detaching operations of the cleaning means.

(Entire Configuration of Image Forming Apparatus)

At first an entire configuration of an image forming apparatus will be explained with reference to FIG. 2. The image forming apparatus of the present embodiment is a full-color image forming apparatus utilizing 4-color toners of yellow, cyan, magenta and black, and is a copying apparatus having a drum, a rotary development structure and an intermediate transfer structure and provided with a digital color image reader part in an upper part of a main body of the apparatus and a digital color image printer part in a lower part of the main body.

In the image forming apparatus of the present embodiment, when a copy key is depressed, an original is optically read in a reader part I provided in the upper part of the apparatus, and is converted into an optical signal of each color (for each color station) in a laser output part, which emits a selective laser light from exposure means 2 to a photosensitive drum 3 thereby executing an exposure.

Around the photosensitive drum 3, there are provided a charger 4 for uniformly charging the surface of the photosensitive drum 3, four developing devices 5a, 5b, 5c, 5d provided rotatably in a developing rotary 5 and serving to form color toner images of yellow, cyan, magenta and black on the photosensitive drum 3 (each color toner being negatively charged in each developing device), and cleaning means 6 which removes toner remaining on the photosensitive drum 3.

The image forming apparatus of the present embodiment executes a development for each color by rotating the developing rotary 5, and exposed images on the photosensitive drum 3 are developed by repeating a process of switching the developing devices 5a, 5b, 5c, 5d by a rotation of the developing rotary 5 each time for a number of necessary colors, and thus developed color toner images are primary transferred each time in superposed manner onto an intermediate transfer belt (intermediate transfer member) 7 thereby obtaining a color image. The intermediate transfer belt 7 is supported by rollers 15a, 15b, 15c and 15d and is rotated clockwise (direction of an arrow A in FIG. 2).

In synchronization with the image formation on the intermediate transfer belt 7, a sheet serving as a transfer material, stacked in a sheet cassette 8 mounted in a lower part of the apparatus is conveyed by sheet conveying means constituted of a feed roller 9, paired separating rollers 10, paired conveying rollers 11 and the like toward a secondary transfer part. Also the sheet may be fed from a manual multi insertion tray 12.

Thereafter, a positive bias is applied to a transfer roller 13 in the secondary transfer part to execute a secondary transfer of the color image, formed on the intermediate transfer belt 7, onto the conveyed sheet (transfer material). Then the sheet, after passing the image transfer part, is subjected to a heat fixation in a fixing part 14, and is discharged or directed to a two-side image forming process.

On the other hand, the intermediate transfer belt 7, after the transfer of the toner image onto the sheet, is subjected to an removal of a residual toner by cleaning means C constituting a cleaning apparatus.

(Cleaning Apparatus)

In the following there will be explained a configuration of the cleaning means (toner removal means) C for the intermediate transfer belt 7. The cleaning means C of the present embodiment employs, as shown in FIG. 3, plural fur brushes as cleaning members. More specifically, there are provided a first fur brush 21 constituting a first touchable/detachable member touchable on or detachable from the intermediate transfer belt 7, a first metal bias roller 22 in contact therewith, and a first cleaning blade 23 for removing the toner on the first bias roller 22. There are also provided a second fur brush 31 constituting a second touchable/detachable member touchable on or detachable from the intermediate transfer belt 7 and positioned at a downstream side of the first fur brush 21 in a rotating direction of the intermediate transfer belt 7, a second metal bias roller 32 in contact therewith, and a second cleaning blade 33 for removing the toner on the second bias roller 32.

A spiral carrying screw 50 is further provided for carrying the toner, removed by the first cleaning blade 23 and the second cleaning blade 33, to an unillustrated toner recovery part.

In the present embodiment, the first fur brush 21 and the second fur brush 31 are formed with electroconductive acryl fibers of an electrical resistance of 10² to 10⁹ Ω·cm. Also the first cleaning blade 23 and the second cleaning blade 33 are formed with an urethane resin of a thickness of 2 to 3 mm.

All the aforementioned components are contained in a housing 60, of which a lower aperture is provided with a film-shaped spill prevention sheet 40 for preventing a leakage of the recovered toner from a gap between the housing 60 and the intermediate transfer belt 7. The spill prevention sheet 40 is constructed as a third touchable/detachable member of which a front end is rendered touchable on or detachable from the intermediate transfer belt 7.

The aforementioned touchable/detachable members, namely the first and second fur brushes 21, 31 and the spill prevention sheet 40 are detached from the intermediate transfer belt 7 when a primary transfer image is transferred on the intermediate transfer belt 7, in order not to perturb the toner image transferred thereon. On the other hand, after the primary transfer image is transferred from the intermediate transfer belt onto the sheet, these members are brought into contact with the intermediate transfer belt 7 for removing the toner remaining thereon.

In the present embodiment, the first and second fur brushes 21, 31 and the spill prevention sheet 40 are rendered independently touchable on or detachable from the intermediate transfer belt 7 by an unillustrated mechanism.

(Cleaning Operation)

In the following, there will be explained a cleaning operation of the intermediate transfer belt 7 by the cleaning means C.

In the cleaning operation of the intermediate transfer belt 7, the first and second fur brushes 21, 31 and the spill prevention sheet 40 are brought to a touching relation with the intermediate transfer belt 7, then the fur brushes 21, 31 are rotated and a negative bias which has an opposite pole to that of the bias which is applied to the second bias roller 32 is applied to the first bias roller 22. Thus a negative bias is applied also to the first fur brush 21 in contact with the first bias roller 22.

By such bias application, a positively charged toner remaining on the intermediate transfer belt 7 after the transfer from the intermediate transfer belt 7 to the sheet S is electrostatically removed by the first fur brush 21. Then the removed toner moves onto the first bias roller 22 and is removed by the first cleaning blade 23.

On the other hand, a positive bias is applied to the second bias roller 32. Thus, a positive DC voltage is applied also to the second fur brush 31 in contact with the second bias roller 32.

Thus a negatively charged toner not cleaned by the first fur brush 21 but remaining on the intermediate transfer belt 7 is electrostatically removed by the second fur brush 31.

The removed toner moves onto the second bias roller 32 and is removed by the second cleaning blade 33.

The toners removed by the first cleaning blade 23 and the second cleaning blade 33 are carried by the aforementioned carrying screw 50 to the unillustrated toner recovery part.

(Pulling Off of Cleaning Means)

In the cleaning means C, the first and second fur brushes 21, 31 and the spill prevention sheet 40 are spaced, as explained before, from the intermediate transfer belt 7 when a toner image is formed thereon. In the following there will be explained a spacing operation of each of these members with reference to FIGS. 4A to 4D and FIG. 5.

In the present embodiment, the intermediate transfer member has a length of 534.1 mm (=170 mmφ) while a formed image has a length of 482.6 mm (=19 inches) and plural images are formed in succession. Also a moving speed of the belt is defined as 300 mm/S.

FIG. 4A shows a state where the first fur brush 21, the second fur brush 31 and the spill prevention sheet 40 are pressed to the intermediate transfer belt 7 whereby the surface thereof can be cleaned.

The cleaning of the intermediate transfer belt 7 is executed within a period after a secondary transfer of a preceding image and before a front end of a succeeding image (front end of a yellow image in the present embodiment) reaches the cleaning means (between (3) and (4) in FIG. 5).

More specifically, within a period after the secondary transfer of a preceding image and before a front end of a succeeding image reaches the first fur brush 21, the second fur brush 31 and the spill prevention sheet 40, the first fur brush 21, the second fur brush 31 and the spill prevention sheet 40 are shifted from a detached state to a touching state.

Thus, the first fur brush 21, the second fur brush 31 and the spill prevention sheet 40 are shifted from a detached state to a touching state in an area of the intermediate transferring belt 7 (non-image area) on which a toner image is not borne.

Then a next image passes the secondary transfer part 6, and immediately before it reaches the cleaning means C, the spill prevention sheet is rotated in a counterclockwise direction in the illustration, thus being detached from the surface of the intermediate transfer belt 7 (FIG. 4B).

The front end of the image is detected by an unillustrated sensor for detecting the position of the belt, and a timer count by an unillustrated control part.

The spill prevention sheet 40, being formed by an elastic sheet member, requires a predetermined time T1, after the start of movement from a touching position on the intermediate transfer belt 7 (broken-lined position in FIG. 4B) to completely reach a pull-off position (solid-lined position in FIG. 4B). For this reason, it has to be operated earlier, at least by T1.

The spill prevention sheet 40 touches the intermediate transfer belt 7 in a slightly bent state, and the residual removed by the sheet is accumulated at a front end portion thereof. When the movement from this state to the pull-off position is started, the toner accumulated on the front end portion of the spill prevention sheet 40 remains on the intermediate transfer belt 7, thereby forming a toner streak on the surface of the intermediate transfer belt 7, indicating a separating position of the spill prevention sheet 40.

However, as the present embodiment is so constructed as to start the movement of the spill prevention sheet 40 to the pull-off position outside an image forming area before the front end of the next image (namely in non-image area), the toner streak formed by the spill prevention sheet 39 on the intermediate transfer belt 7 does not overlap with the next image.

Then, after a lapse of a predetermined time T2 from the state of FIG. 4B (spacing operation of the spill prevention sheet 40), the first fur brush 21 is spaced as shown in FIG. 4C ((5) in FIG. 5).

Also in this state, a toner streak is developed by the spacing of the first fur brush 21 as in the case of the spill prevention sheet 40, but, as the first fur brush 21 is so constructed as to be detachable from the intermediate transfer belt 7 in a non-image area as in the case of the spill prevention sheet 40, the toner streak formed by the first fur brush 21 on the intermediate transfer belt 7 does not overlap with the next image.

Then, after a lapse of a predetermined time T3 from the state of FIG. 4C (spacing operation of the first fur brush 21), the second fur brush 31 is detached from the intermediate transfer belt 7 as shown in FIG. 4D ((6) in FIG. 5).

Also in this state, a toner streak is developed by the spacing operation as in the case of the spill prevention sheet 40 and the first fur brush 21, but as the second fur brush 31 is so constructed as to be detached from the intermediate transfer belt 7 in a non-image area as explained before, the toner streak formed by the second fur brush 31 on the intermediate transfer belt 7 does not overlap with the next image.

In case plural members touchable on or detachable from the intermediate transfer belt 7 are provided as in the present embodiment, toner streaks are formed by all these members (in the present embodiment, three streaks by three members), but an image defect is not encountered when all the streaks are contained in the non-image area.

A condition therefor will be explained with reference to FIG. 1. There is required a condition:
(L2/VB)−(L1/VB)>T1−(T2+T3)
wherein L2: length of non-image area, L1: range of cleaning means, VB: velocity of the intermediate transfer belt, T1: spacing time of the spill prevention sheet 40, T2: difference in spacing times of the spill prevention sheet 40 and the first fur brush 21, and T3: difference in spacing times of the first fur brush 21 and the second fur brush 31.

As an example, specific numerical values are considered in case of an image forming apparatus with a photosensitive drum of a diameter of 85 mmφ. The intermediate transfer member is selected with a twice peripheral length of 534.1 mm (=170 mmφ) and a length of a maximum image to be prepared is assumed as 482.6 mm (19 inches). Thus a length L2 of the non-image area becomes:
L2=534.1 mm−482.6 mm=51.5 mm.

In case the first fur brush 21 and the second fur brush 31 have a diameter of 20 mmφ and a contacting opposed roller has a diameter of 36 mmφ, a range L1 of the cleaning means from the front end of the spill prevention sheet to the second fur brush becomes about 36 mm. For a moving speed of the intermediate transfer belt of 300 mm/s, a following relation stands:
(L2/VB)−(L1/VB)=(51.5/300)−(36/300)=51.2 msec.

A time difference is not particularly required in case the time T1 required for the pull-off the spill prevention sheet is within the aforementioned value, but time differences T2, T3 are required in case the time T1 exceeds such value.

In such configuration as explained above, by rendering plural members of the cleaning means C, touchable on or detachable from the intermediate transfer belt 7, independently detachable with specified time differences, all the plural members can be detached within the non-image area on the intermediate transfer belt 7. It is thus possible to prevent a deterioration of the image quality by a toner streak formed on the intermediate transfer belt 7 at the spacing operation of the cleaning members.

In the present embodiment, three components, namely two fur brushes 21, 31 and the spill prevention sheet 40, are detached from the intermediate transfer belt 7, and, in consideration of a toner streak generation at the detaching operation, it is preferable that these members are detached from the intermediate transfer belt 7 in an as far as close positions.

The as far as close positions mean that, with respect to the detaching position of the first fur brush 21 from the intermediate transfer belt 7, the second fur brush is detached from the intermediate transfer belt 7 at a position within ±3 mm in the rotating direction of the intermediate transfer belt 7. Stated differently, the second fur brush 31 is detached from the intermediate transfer belt 7 within a period of ±0.01 sec with respect to a time when the detaching position of the first fur brush 21 on the intermediate transfer belt 7 reaches the touching position of the second fur brush 31 on the intermediate transfer belt 7.

Conditions for detaching the members at a same position of the intermediate transfer belt 7 are given by setting a pull-off time difference T2 of the spill prevention sheet 40 and the first fur brush 21 and a pull-off time difference T3 of the first fur brush 21 and the second fur brush 31 as follows:
T2=L3/VB
T3=L4/VB
wherein L3: a circumferential distance of the belt between the spill prevention sheet 40 and the first fur brush 21, and L4: a circumferential distance of the belt between the first fur brush 21 and the second fur brush 31.

An example of specific numerical values for L3=10 mm, L4=22 mm and VB=300 mm/s are given by:
T2=10/300=33.3 msec
T3=22/300=73.3 msec
and, by such setting, the three toner streaks caused by the first and second fur brushes 21, 31 and the spill prevention sheet 40 are formed in a substantially single line.

Thus, in detaching the plural cleaning members touching the intermediate transfer belt 7, by so selecting the detaching timings as to execute the detaching in approximate same positions within the non-image area of the intermediate transfer belt 7, it is rendered possible to reduce the toner streaks remaining on the intermediate transfer belt 7 thereby effectively preventing a deterioration of the image quality.

The above-described embodiment shows an example of employing two fur brushes, but such number is not restrictive and there may be employed a fur brush or three or more brushes.

Also the member touching with or detaching from the intermediate transfer belt 7 is not limited to a fur brush or a spill prevention sheet, and the present invention is likewise applicable to other members such as a cleaning blade for scraping off the toner remaining on the intermediate transfer belt 7.

### Second Embodiment

In the following there will be explained a configuration of a cleaning apparatus C for the intermediate transfer belt 7 in a second embodiment. The cleaning apparatus C of the present embodiment is constituted, as shown in FIG. 5, of a first cleaning part 20 constituting first cleaning means which principally cleans a positively charged toner, a second cleaning part 30 constituting second cleaning means which principally cleans a negatively charged toner, a spill prevention sheet 40 formed by a sheet member for sealing a gap between a case 60 and an intermediate transfer belt 7 in order to avoid a leakage of a toner removed from the surface of the intermediate transfer belt 7, a carrying screw 50 constituting toner carrying means which carries the toner, removed by a first cleaning blade (first blade) 23 and a second cleaning blade (second blade) 33, to an unillustrated toner recovery part, and a cleaner case 601 and an upper cover 602 for integrally supporting these members.

The cleaning apparatus of the second embodiment is used, as in the first embodiment, in an image forming apparatus shown in FIGS. 4A to 4D. The image forming apparatus shown in FIGS. 4A to 4D, having a configuration same as in the first embodiment except for the cleaning apparatus C, will not be explained further.

The first cleaning part 20 is constituted of a first fur brush 21 as a first touchable/detachable member, a first metal bias roller (first roller) 22 in contact with the first fur brush 21 for applying a bias thereto, a first cleaning blade 23 maintained in contact with the first bias roller 22 in a contact area B1 for removing a toner on the surface thereof, and a first cleaning support member 24 integrally supporting these three members and rotatably supported about a fulcrum 25 with respect to the cleaner case 60.

Similarly, the second cleaning part 30 is constituted of a second fur brush 31 as a second touchable/detachable member, a second metal bias roller (second roller) 32 in contact with the second fur brush 31 for applying a bias thereto, a second cleaning blade 33 maintained in contact with the second bias roller 32 in a contact area B2 for removing a toner on the surface thereof, and a second cleaning support member 34 integrally supporting these three members and rotatably supported about a fulcrum 35 with respect to the cleaner case 60.

The spill prevention sheet 40 is a film-shaped sheet, which is positioned in a lower aperture of the cleaner case 60 and is rotatably supported thereto about a fulcrum 41.

The brushes employed in the first fur brush 21 and the second fur brush 31 are formed with electroconductive acryl fibers of an electrical resistance of 10² to 10⁹ Ω·cm. Also the first cleaning blade 23 and the second cleaning blade 33 are formed with an urethane resin of a thickness of 2 to 3 mm.

Also the first cleaning support member 24 and the second cleaning support member 34 are so constructed as to be independently rotatable respectively about the fulcrums 25, 35. Thus the first fur brush 21 and the second fur brush 31 are rendered independently touchable on or detachable from the intermediate transfer belt 7.

Also a sheet support member 42 supporting the spill prevention sheet 40 is rendered rotatable, by unillustrated drive means, independently from the the first cleaning support member 24 and the second cleaning support member 34. Therefore the spill prevention sheet 40 is rendered touchable on or detachable from the intermediate transfer belt 7 rotating in a direction A in FIG. 5, independently from the fur brushes 21, 31.

(Cleaning Operation)

In the following, there will be explained a cleaning operation of the intermediate transfer belt 7 by the cleaning means C.

In the cleaning operation of the intermediate transfer belt 7, the first and second fur brushes 21, 31 and the spill prevention sheet 40 are brought to a touching relation with the intermediate transfer belt 7, then the fur brushes 21, 31 are rotated and a negative bias is applied to the first bias roller 22. Thus a negative bias is applied also to the first fur brush 21 in contact with the first bias roller 32.

By such bias application, a positively charged toner remaining on the intermediate transfer belt 7 after the transfer from the intermediate transfer belt 7 to the sheet S is electrostatically removed by the first fur brush 21. Then the removed toner moves onto the first bias roller 22 and is removed by the first cleaning blade 23.

On the other hand, a positive bias is applied to the second bias roller 32. Thus, a positive DC voltage is applied also to the second fur brush 31 in contact with the second bias roller 32.

By such bias application, a negatively charged toner not cleaned by the first fur brush 21 but remaining on the intermediate transfer belt 7 is electrostatically removed by the second fur brush 31. The removed toner moves onto the second bias roller 32 and is removed by the second cleaning blade 33.

The toners removed by the first cleaning blade 23 and the second cleaning blade 33 are carried by the aforementioned carrying screw 50 to the unillustrated toner recovery part.

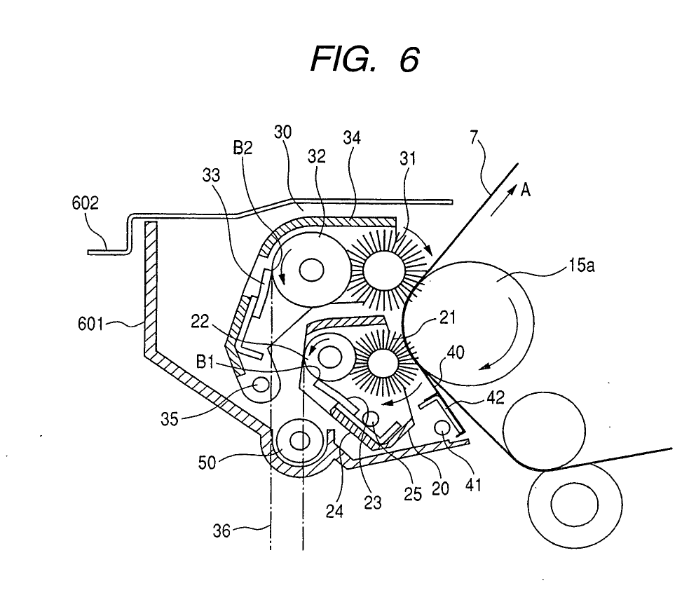

The second fur brush 31 has a diameter larger than that of the first fur brush 21, and the second bias roller 32 has a diameter larger than that of the second bias roller 22. The second cleaning part 30 is positioned vertically above the first cleaning part 20, but, because of the aforementioned larger diameters, a removing position (indicated by a line 36 in FIG. 6) between the second bias roller 32 and the second cleaning blade 33 for removing the toner thereon is positioned outside the vertically upward direction (in the present embodiment, to the left in FIG. 6) of the first fur brush 21 and the second bias roller 22, whereby the toner removed by the second cleaning blade 33 does not directly drop onto the first cleaning part 20.

That is, the contact area between the second bias roller 32 and the second cleaning blade 36 is positioned vertically above the first fur brush 21, the first bias roller 22 and the first cleaning blade 23 in an installed state of the image forming apparatus, and wherein in an installed state of the image forming apparatus, the first cleaning blade 23, the first bias roller 22 and the first cleaning blade 23 are projected outside of areas on which the second roller and the second blade are projected with respect to a direction from a vertical top of said image forming apparatus to a bottom side of the image forming apparatus.

The first and second fur brushes 21, 31 and the spill prevention sheet 40 of the cleaning apparatus C are detached, like the first and second fur brushes 21, 31 and the spill prevention sheet 40 of the cleaning apparatus C in the first embodiment, from the intermediate transfer belt 7 at an image formation thereon.

In the second embodiment, the detaching operations of the first and second fur brushes 21, 31 and the spill prevention sheet 40 from the intermediate transfer belt 7 are same as those of the first embodiment explained with reference to FIG. 5, and will not, therefore, be explained further.

Also in the second embodiment, the first and second fur brushes 21, 31 and the spill prevention sheet 40 are shifted, as in the first embodiment from a detached state from the intermediate transfer belt 7 to a touching state thereto, within a period after a secondary transfer of a preceding image and before a front end of a next image reaches the first and second fur brushes 21, 31 and the spill prevention sheet 40. Also the first and second fur brushes 21, 31 and the spill prevention sheet 40 are shifted from the detached state to the touching state in an area of an intermdediate transferring belt 7 (non-image area) on Which a toner image is not borne.

In the present embodiment, three components, namely two fur brushes 21, 31 and the spill prevention sheet 40, are detached from the intermediate transfer belt 7, and, in consideration of a toner streak generation at the detaching operation, it is preferable that these members are detached from the intermediate transfer belt 7 in an as far as close positions.

The as far as close positions mean that, with respect to the detaching position of the first fur brush 21 from the intermediate transfer belt 7, the second fur brush is detached from the intermediate transfer belt 7 at a position within ±3 mm in the rotating direction of the intermediate transfer belt 7. Stated differently, the second fur brush 31 is detached from the intermediate transfer belt 7 within a period of ±0.01 sec with respect to a time when the detaching position of the first fur brush 21 on the intermediate transfer belt 7 reaches the touching position of the second fur brush 31 on the intermediate transfer belt 7.

In the present embodiment, as the first and second fur brushes 21, 31 and the spill prevention sheet 40 touchable on or detachable from the intermediate transfer belt 7 are independently detachable from the intermediate transfer belt 7, each member is so set as to be detached from the intermediate transfer belt 7 in the non-image area thereon.

Also in the first cleaning part 20 and the second cleaning part 30, the fur brushes 21, 31, the bias rollers 22, 32 and the cleaning blades 23, 33 are supported by the cleaning support members 24, 34 and are moved in an integrally supported state, so that the cleaning property is not deteriorated by the pull-off operation.

Also as the first cleaning part 20 and the second cleaning part 30 are rendered independently rotatable in a single cleaner case 60 and the toner discharge to the exterior is executed by the single carrying screw 50, the cleaning-apparatus itself can be realized smaller with a lower cost.

Also the member touching with or detaching from the intermediate transfer belt 7 is not limited to a fur brush or a spill prevention sheet, and the present invention is likewise applicable to other members such as a cleaning blade for scraping off the toner remaining on the intermediate transfer belt 7.

This application claims priorities from Japanese Patent Application Nos. 2004-119879 filed on Apr. 15, 2004 and 2004-130782 filed on Apr. 27, 2004, which are hereby incorporated by reference herein.

1. An image forming apparatus comprising:
an image bearing member which bears an image and rotates in a predetermined direction; and
a first toner removal member which is able to be touchable to or detachable from said image bearing member, said first toner removal member being detached from said image bearing member in an area in which an toner image on said image bearing member is not borne and removing toner on said image bearing member by applying bias with a predetermined pole in an area in which said first toner removal member touches said image bearing member;
a second toner removal member which is positioned in a downstream side of said first toner removal member in the predetermined direction and is able to be touchable to or detachable from said image bearing member, said second toner removal member being detached from said image bearing member in an area in which an toner image on said image bearing member is not borne and removing toner on said image bearing member by applying bias with another pole opposite to the predetermined pole in an area in which said second toner removal member touches said image bearing member,
wherein the first touchable/detachable member and the second touchable/detachable member are detached from the image bearing member at approximately same positions.

2. An image forming apparatus according to claim 1, wherein the first and second toner removal members are brush rollers which rotate in contact with said image bearing member.

3. An image forming apparatus according to claim 2, comprising:
a first roller which removes a toner adhering to said first toner removal member by contacting said first toner removal member;
a first blade which removes a toner adhering to the first roller by contacting said first roller;
a second roller which removes a toner adhering to said second removal member by contacting said second toner removal member; and
a second blade which removes a toner adhering to the second roller by contacting said second roller,
wherein a contact area between said second roller and said second blade is positioned vertically above the first toner removal member, the first roller and the first blade in an installed state of the image forming apparatus,
and wherein in an installed state of the image forming apparatus, the first toner removal member, the first roller and the first blade are projected outside of areas on which the second roller and the second blade are projected with respect to a direction from a vertical top of said image forming apparatus to a bottom side of the image forming apparatus.

4. An image forming apparatus according to claim 3, wherein the second toner removal member has a diameter larger than that of the first toner removal member.

5. An image forming apparatus according to claim 4, wherein the second roller has a diameter larger than that of the first roller.
